(19) United States
(12) Patent Application Publication
(10) Pub. No.: US 2016/0256344 A1
(43) Pub. Date: Sep. 8, 2016

(54) Leg Stretching Device

(71) Applicant: Seung Hyun Lee, Seoul (KR)

(72) Inventor: Seung Hyun Lee, Seoul (KR)

(21) Appl. No.: 15/051,172

(22) Filed: Feb. 23, 2016

(30) Foreign Application Priority Data
Mar. 5, 2015 (KR) 10-2015-0031180

(51) Int. Cl. A61H 1/02; A63B 21/002

(52) U.S. Cl. CPC A61H 1/0237; A63B 21/0023

(57) ABSTRACT

A leg stretching device is provided, which can provide a stable, efficient leg stretching effect for leg stretching methods and legs of users because the leg stretching device has flexible responses to the method and legs of users. The leg stretching device includes a fixed housing having a fastening hole and a coupling groove, a movable housing penetratingly coupled to the fastening hole of the fixed housing to be movable and having a support means provided on one side thereof to enable a user seated thereon, a pair of auxiliary housings detachably coupled to the coupling groove of the fixed housing in an opposite direction thereto, and a connection portion having one side connected to the fixed housing and the other side connected to the movable housing to control movement of the movable housing in a length direction thereof.

### CROSS-REFERENCE TO RELATED APPLICATION

This application is based on and claims priority from Korean Patent Application No. 10-2015-0031180 filed on Mar. 5, 2015 in the Korean Intellectual Property Office, the disclosure of which is incorporated herein in its entirety by reference.

### TECHNICAL FIELD

The present invention relates to a leg stretching device, and more particularly to a leg stretching device which can be conveniently installed in a place where leg stretching is to be performed and can achieve efficient leg stretching. The leg stretching device according to the present invention can be safely used without risk of damage through a simple coupling structure that is connected without any complicated mechanical configuration, that is, through a configuration of a connection portion connecting a fixed housing and a movable housing to each other, even in a user's leg stretching process, and can obtain smooth leg stretching effects through the movable housing that moves forward and backward to smoothly correspond to movement of user's legs that perform leg stretching and the connection portion coupled to the movable housing.

### BACKGROUND OF THE INVENTION

Stretching that loosens muscles, a tendon, or a ligament of a body region may mean exercise which can increase the movable range of a joint, maintain and improve flexibility, and help a body to prevent injury.

The principle of such stretching is to lengthen muscles from its natural state through extension of the length of the muscles, and in order to improve flexibility, it is general to lengthen the muscles so that the length of the muscles is increased by about 10% in comparison to the normal length of the muscles.

As described above, the stretching that can relieve the tension of the human body and improve the flexibility may be performed to lengthen the muscles of arms and legs of the human body without any separate device, or may be performed to lengthen the muscles of a body region of which the stretching is to be performed using a stretching device that can achieve smooth stretching.

Further, in the case of lengthening the muscles using the stretching device, the muscles of a body region of which the stretching is to be performed are lengthened using a lower-body or upper-body stretching device in accordance with the body region of which the stretching is to be performed. In particular, in the case of the upper human body, the upper body muscles of which the stretching is to be performed can be smoothly lengthened using both arms, whereas in the case of the lower human body, using a separate stretching device can heighten the stretching efficiency.

For example, in the case of lengthening the lower body (legs) using the stretching device, as described in Document 1, Document 2, and Document 3, devices that can stretch user's legs using stretching devices have been proposed.

However, the leg stretching devices in the related art as described above have the problems that it is difficult for a user to conveniently use the leg stretching devices due to their complicated mechanical constructions. Further, since it is difficult to conveniently carry or to take custody of the leg stretching devices, it becomes difficult for a user to achieve smooth use of the leg stretching devices through changing of the installation positions of the stretching devices.

Further, if a part of the device is damaged while the device is in use, it is difficult to easily change only the damaged region of the device, and thus unnecessary maintenance costs, such as repurchase costs, are increased.

Further, as described in Document 4, in the case of the leg stretching device in the related art, the structure of the device, which is connected to be horizontally movable in accordance with a pulling force (attractive force) to make both legs spread out, may move in upward and downward direction, and thus a part of the leg stretching device positioned at the end that faces a user may ascend. Accordingly, it is difficult to continue stretching of both legs as long as a desired time and to form the maximum leg stretching angle of 180°, and thus the leg stretching efficiency deteriorates.

### PRIOR ART DOCUMENT

### Patent Document

(1) Korean Patent Application Publication No. 10-2013-0122600 (Published on Nov. 7, 2013)
(2) Korean Patent Application Publication No. 10-2004-0069026 (Published on Aug. 4, 2004)
(3) Korean Patent Application Publication No. 10-2008-0110418 (Published on Dec. 18, 2008)
(4) Korean Registered Patent No. 10-2004-0794700 (Registered on Feb. 7, 2006)

### SUMMARY OF THE INVENTION

Accordingly, the present invention has been made to solve the above-described problems, and one subject to be achieved by the present invention is to provide a leg stretching device, which can be installed in a place where leg stretching is to be performed and can achieve efficient leg stretching in accordance with the leg pressure of a user seated on an upper portion of a movable housing through the movable housing that moves corresponding to the leg pressure of the user and a connection portion connected to the movable housing to form pressure in the movable housing so as to move in a user direction, in the case where it is intended to perform the leg stretching using the movable housing that is coupled to a fixed housing through the connection portion.

Another subject to be achieved by the present invention is to provide a leg stretching device, which can achieve efficient and stable leg stretching even during installation and utilization of the leg stretching device through flexibly coping with sudden movements of a user who performs the leg stretching and maximally reducing the risk of damage, and thus can obtain the overall cost reduction effects in achieving the leg stretching.

Still another subject to be achieved by the present invention is to provide a leg stretching device, which can facilitate custody and carriage thereof through configuration of a fixed housing, a movable housing, and a connection portion that can be assembled and disassembled, and can secure convenience in use through easy replacement of a damaged component.

Yet still another subject to be achieved by the present invention is to provide a leg stretching device, which can achieve efficient use through only a simple coupling of a fixed housing, a movable housing, and a connection portion without any complicated mechanical configuration, and thus can prevent unnecessary purchase, installation, and maintenance costs from being increased.

In accordance with one aspect of the present invention, there is provided a leg stretching device, which includes a fixed housing being in the form of a long type bar and having a fastening hole provided in an inner center portion thereof and a coupling groove provided on both side portions thereof; a movable housing being in the form of a long type bar to be penetratingly coupled to the fastening hole of the fixed housing to be movable and having a support means provided on one side thereof to enable a user seated thereon; and a pair of auxiliary housings detachably coupled to the coupling groove of the fixed housing in an opposite direction thereto.

In accordance with another aspect of the present invention, there is provided a leg stretching device, which includes a fixed housing being in the form of a long type bar and having a fastening hole provided in an inner center portion thereof and a coupling groove provided on both side portions thereof; a movable housing being in the form of a long type bar to be penetratingly coupled to the fastening hole of the fixed housing to be movable and having a support means provided on one side thereof to enable a user seated thereon; a pair of auxiliary housings detachably coupled to the coupling groove of the fixed housing in an opposite direction thereto; and a connection portion having one side connected to the fixed housing and the other side connected to the movable housing to firmly maintain coupling between the fixed housing and the movable housing and to control movement of the movable housing in a length direction thereof.

The fixed housing may have first insertion holes formed on an upper side of the fastening hole to which the movable housing is coupled and second insertion holes formed on an upper side of the coupling groove to which the auxiliary housings are coupled, the movable housing may have a plurality of connection holes provided in a length direction thereof to correspond to the first insertion holes, and the auxiliary housing may have a plurality of fixing holes provided in a length direction thereof to correspond to the second insertion holes.

The connection portion may include a tension wire penetrating the fixed housing and having one side connected to the movable housing and a connection body detachably coupled to one side of the fixed housing through a fastening bolt so that a length of the tension wire can be adjusted, and the connection body may include a body portion detachably coupled to one side of the fixed housing through the fastening bolt and an adjustment handle connected to one side of the tension wire and rotatably coupled to an upper side of the body portion.

The body portion may have a plurality of through-holes to which the fastening bolt is coupled and a connection hole to which the adjustment handle is rotatably fastened, and the adjustment handle may include a handle body having a movable hole provided on one side thereof and rotatably coupled to the connection hole and a fixed bar connected to the movable hole to be movable upward and downward.

The fixed housing may have a wire connection hole having an inner groove so that the tension wire is penetratingly seated thereon, and a fixing means seated in the groove to fix the moving tension wire may be coupled to the wire connection hole.

A connection ring to which the tension wire is coupled may be further provided on one side of the handle body, and a cover that is formed to be contractible to prevent the tension wire from being exposed to an outside may be further provided on a connection region between the fixed housing and the movable housing to which the tension wire is connected.

A movement prevention means may be further coupled to lower ends of the movable housing and the auxiliary housings, which is formed of any one selected from the group including rubber, synthetic resin, and a metal material to prevent movements of the movable housing and the auxiliary housings.

The support means may be composed of a chair having a backrest region on which a plurality of pressure projections are arranged.

The present invention as described above may have the following effects.

First, according to the leg stretching device that can be used to stretch the leg region of the human body, efficient and stable leg stretching can be achieved by flexibly coping with sudden movements of the user who performs the leg stretching through the configuration of the movable housing that is movably coupled to the fixed housing through the connection portion.

Second, efficient leg stretching effects can be provided in accordance with user's figure and exercise types through adjustment of the coupling position between the movable housing coupled to the fixed housing and the auxiliary housings.

Third, the leg stretching device can be conveniently carried and installed in a desired position and can be conveniently given in the custody of the user through the configuration of the fixed housing, the movable housing, the auxiliary housings, and the connection portion that can be assembled and disassembled even without complicated configurations.

Fourth, even in the case where any one of the fixed housing, the movable housing, the auxiliary housings, and the connection portion is damaged, the damaged one can be easily replaced through the configuration of the fixed housing, the movable housing, the auxiliary housings, and the connection portion that can be assembled and disassembled. Accordingly, it is possible to secure convenience in use and to prevent unnecessary manufacturing cost and maintenance cost from being increased.

Fifth, the stretching device can be safely used without the risk of damage even in the leg stretching process through the configuration of the connection portion that connects the fixed housing and the movable housing to each other, and can achieve smooth and efficient leg stretching through the configuration of the movable housing and the connection portion that are configured to smoothly coping with the leg movements of the user who performs the leg stretching.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a combined perspective view illustrating a leg stretching device according to an embodiment of the present invention;

FIG. 2 is an exploded perspective view illustrating a leg stretching device according to an embodiment of the present invention;

FIG. 3 is a perspective view illustrating a use state of a leg stretching device according to an embodiment of the present invention;

FIG. 4 is an exploded perspective view illustrating a leg stretching device according to another embodiment of the present invention;

FIG. 5 is a combined perspective view illustrating a leg stretching device according to another embodiment of the present invention;

FIG. 6 is a combined perspective view illustrating an operation state of a fixed housing and a movable housing of a leg stretching device according to another embodiment of the present invention;

FIG. 7 is a side view illustrating a coupling state of a leg stretching device according to another embodiment of the present invention;

FIG. 8 is an enlarged view of an extracted main portion illustrating a connection portion of a leg stretching device according to another embodiment of the present invention;

FIG. 9 is an enlarged view of an extracted main portion illustrating a coupling state of a fixed housing and a connection portion of a leg stretching device according to another embodiment of the present invention;

FIG. 10 is a combined perspective view of an extracted main portion illustrating a connection portion of a leg stretching device according to another embodiment of the present invention;

FIG. 11 is a perspective view illustrating a leg stretching device to which a cover is coupled according to another embodiment of the present invention; and

FIG. 12 is a perspective view illustrating a use state of a leg stretching device according to another embodiment of the present invention.

### DETAILED DESCRIPTION OF THE INVENTION

Hereinafter, preferred embodiments of the present invention will be described in detail with reference to the accompanying drawings.

The embodiments to be described hereinafter are nothing but specific details provided to assist those of ordinary skill in the art in a comprehensive understanding of the invention, and thus do not mean that the technical idea and scope of the present invention are limited thereto. In giving drawing reference numerals to respective constituent elements, the same reference numerals are given to the same constituent element across the figures. Further, all terms that are specially defined in consideration of the configuration and operation of the present invention may differ depending on intentions of a user or an operator or customs, and thus they should be defined on the basis of the contents of the whole description of the present invention.

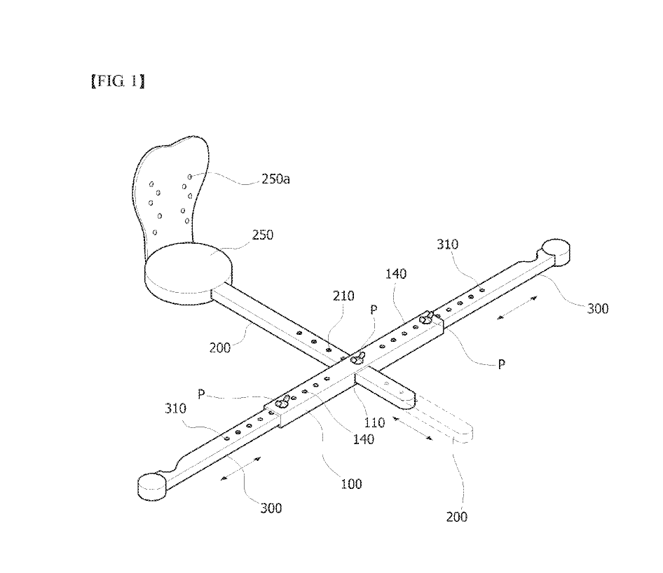

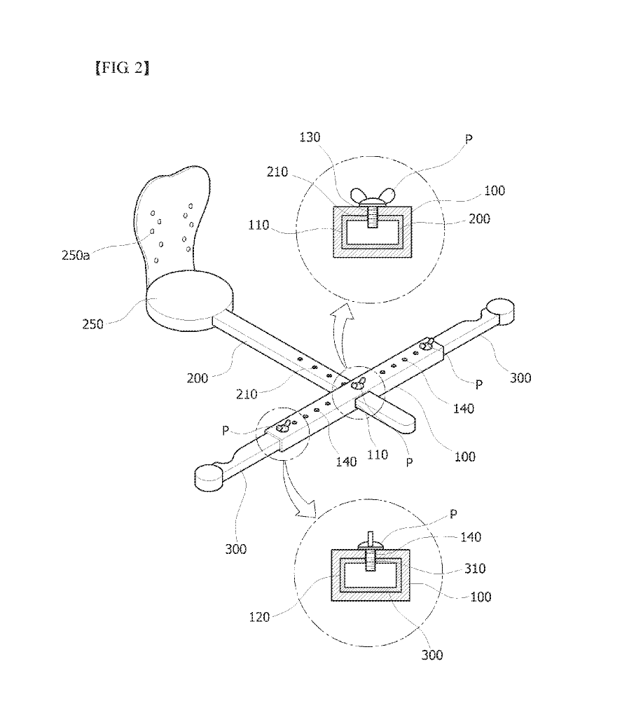

First, referring to FIGS. 1 to 3, the configuration of a leg stretching device according to an embodiment of the present invention will be described.

A leg stretching device according to an embodiment of the present invention includes a fixed housing 100 being in the form of a long type bar and having a fastening hole 110 provided in an inner center portion thereof and a coupling groove 120 provided on both side portions thereof, a movable housing 200 being in the form of a long type bar to be penetratingly coupled to the fastening hole 110 of the fixed housing 100 to be movable and having a support means 250 provided on one side thereof to enable a user seated thereon, and a pair of auxiliary housings 300 detachably coupled to the coupling groove 120 of the fixed housing 100 in an opposite direction thereto.

As illustrated in FIG. 1, the fixed housing 100 is formed in a long type bar shape, and is provided with the fastening hole 110 and the coupling groove 120 to which the movable housing 200 and the auxiliary housings 300 can be coupled.

In this case, it is preferable that the fixed housing 100 is formed of a metal material or a plastic material that has high strength and light weight so that a user can conveniently carry and smoothly install the leg stretching device according to the present invention in a desired place to use the leg stretching device.

Although it is illustrated and described that the fixed housing 100 according to an embodiment of the present invention is configured to be in the long type bar shape, the present invention is not limited thereto. The shapes or configurations of the fixed housing 100, the movable housing 200, and the auxiliary housings 300 may be variously changed so far as they can firmly maintain the coupling state after they are movably coupled to each other.

Further, the fixed housing 100 includes first insertion holes 130 formed on an upper side of the fastening hole 110 to which the movable housing 200 is coupled and second insertion holes 140 formed on an upper side of the coupling groove 120 to which the auxiliary housings 300 are coupled.

In the case where the movable housing 200 and the auxiliary housings 300 are coupled to the fixed housing 100, the first and second insertion holes 130 and 140 firmly maintain the coupling between the fixed housing 100 and the movable housing 200 and the coupling of the auxiliary housings 300 that are coupled to one side of the movable housing 200.

Further, the movable housing 200 includes a plurality of connection holes 210 provided in a length direction thereof to correspond to the first insertion holes 130 of the fixed housing 100, and the auxiliary housing 300 includes a plurality of fixing holes 310 provided in a length direction thereof to correspond to the second insertion holes 140.

As illustrated in FIGS. 1 to 3, such configuration is to achieve the firm coupling through adjustment of the coupling state of the fixed housing 100 and the movable housing 200 through an adjustment bolt P that is fastened to the first insertion hole 130 and the connection hole 210 and to achieve the firm coupling through adjustment of the coupling state of the auxiliary housings that are coupled to both sides of the movable housing 200 and one side of the movable housing 200 in the case where it is intended to make the movable housing 200 coupled to the fastening hole 110 of the fixed housing 100 in configuring the leg stretching device according to an embodiment of the present invention.

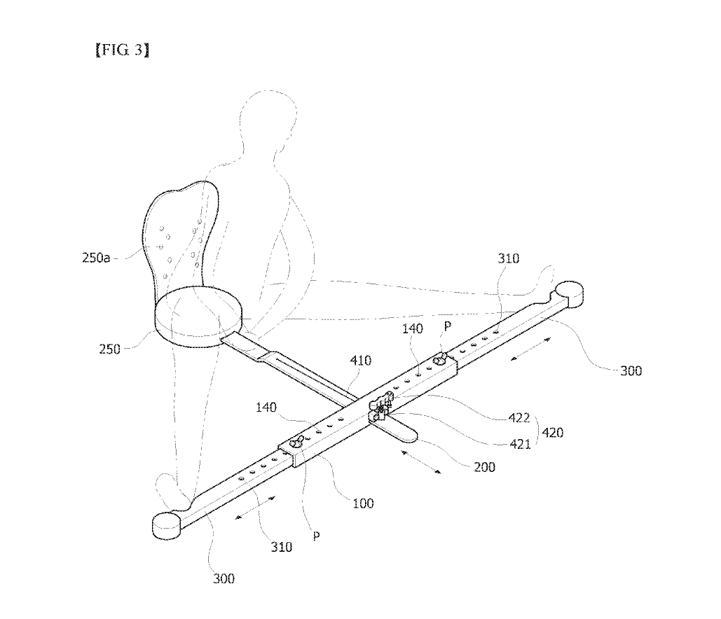

In this case, it is preferable that the movable housing 200 and the auxiliary housings 300 are formed of a metal material or a plastic material that has high strength and light weight so as to prevent them from being bent or damaged even in the case where a user uses them to perform the leg stretching as illustrated in FIG. 3.

Through the above-described configuration, as illustrated in FIG. 3, even in the case where the user intends to perform the leg stretching in a state where the user is seated on the upper portion of the support means 250, smooth leg stretching can be achieved through adjustment of the coupling state of the fixed housing 100, the movable housing 200, and the auxiliary housings 300.

That is, even in the case of coupling the movable housing 200 to the fastening hole 110 of the fixed housing 100, as illustrated in FIG. 3, the user can adjust the leg stretching angle through movement of the movable housing 200 in a state where the movable housing 200 is inserted into the fastening hole 110, and after the angle adjustment is performed, the coupling state of the fixed housing 100 and the movable housing 200 can be firmly maintained through the adjustment bolt P that is fastened to the first insertion hole 130 of the fixed housing 100 and the connection hole 210 to achieve the stable use of the leg stretching device.

Further, even in the case of coupling the auxiliary housings 300 to the coupling groove 120 of the fixed housing 100, as illustrated in FIG. 3, the user can adjust the leg stretching angle through movement of the auxiliary housings 300 in a state where the auxiliary housings 300 are coupled to the coupling groove 120, and after the angle adjustment is performed, the coupling state of the fixed housing 100 and the auxiliary housings 300 can be firmly maintained through the adjustment bolt P that is fastened to the second insertion hole 140 of the fixed housing 100 and the fixing holes 310 of the auxiliary housings 300 to achieve the stable leg stretching process.

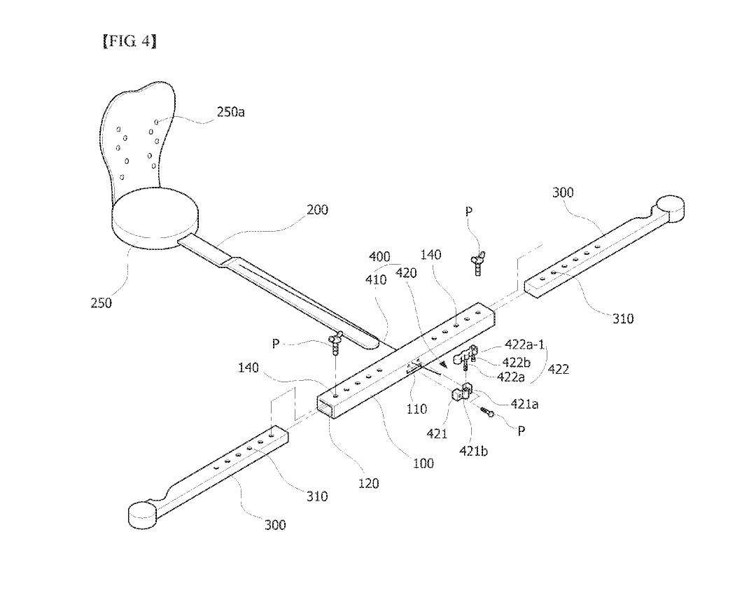

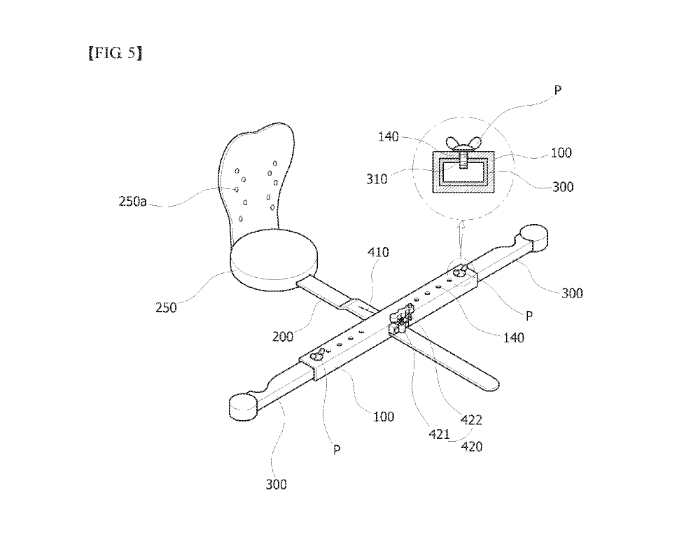

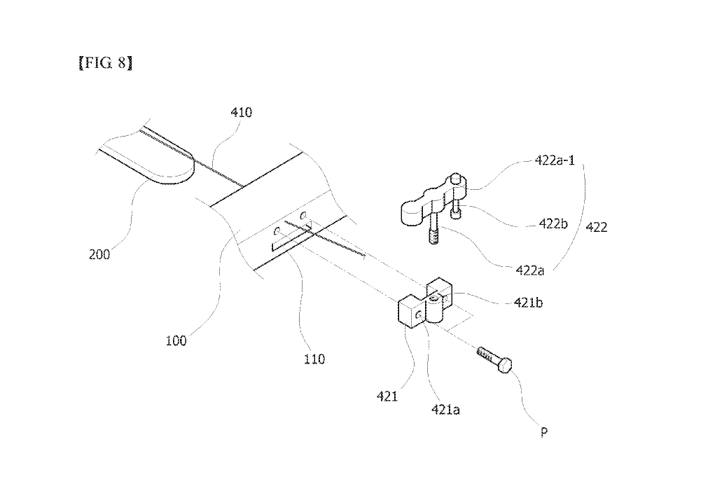

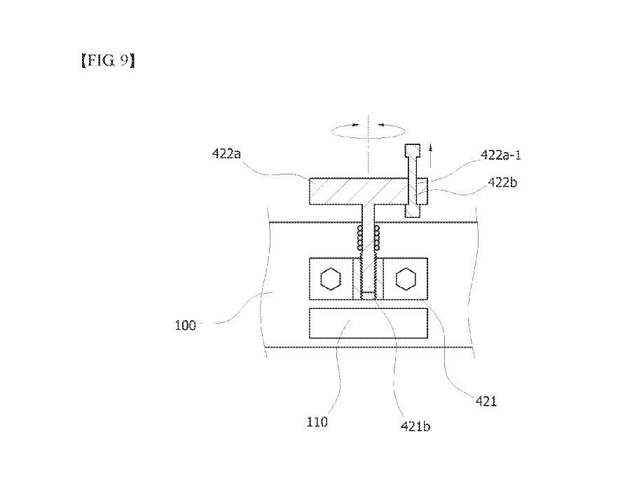

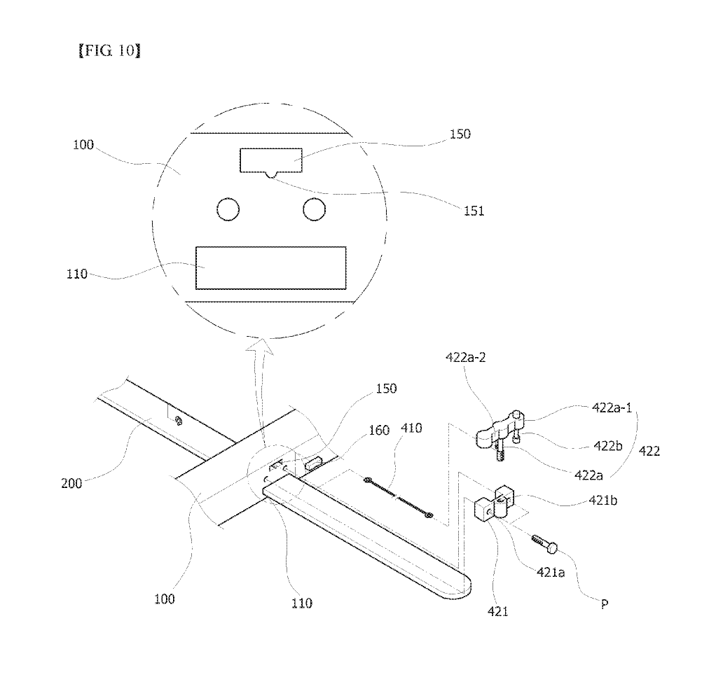

Hereinafter, referring to FIGS. 4 to 12, the configuration of a leg stretching device according to another embodiment of the present invention will be described.

A leg stretching device according to another embodiment of the present invention includes a fixed housing 100 being in the form of a long type bar and having a fastening hole 110 provided in an inner center portion thereof and a coupling groove 120 provided on both side portions thereof, a movable housing 200 being in the form of a long type bar to be penetratingly coupled to the fastening hole 110 of the fixed housing 100 to be movable and having a support means 250 provided on one side thereof to enable a user seated thereon, a pair of auxiliary housings 300 detachably coupled to the coupling groove 120 of the fixed housing 100 in an opposite direction thereto, and a connection portion 400 having one side connected to the fixed housing 100 and the other side connected to the movable housing 200 to firmly maintain coupling between the fixed housing 100 and the movable housing 200 and to control movement of the movable housing 200 in a length direction of the movable housing 200.

According to this configuration, the coupling of the fixed housing 100 to the movable housing 200 is not performed through the adjustment bolt P that is fastened to the first insertion hole 130 that is formed on the fixed housing 100 and the connection hole 210 of the movable housing 200 that is formed to correspond to the first insertion hole 130 as illustrated in FIG. 1, but the coupling is firmly performed by adjusting the coupling of the fixed housing 100 and the movable housing 200 through the connection portion 400 that connects the fixed housing 100 and the movable housing 200 to each other.

In this case, as illustrated in FIG. 4, it is preferable that the fixed housing 100 is formed in a long type bar shape, and is provided with the fastening hole 110 and the coupling groove 120 to which the movable housing 200 and the auxiliary housings 300 can be coupled.

Further, it is preferable that the fixed housing 100 is formed of a metal material or a plastic material that has high strength and light weight so that a user can conveniently carry and smoothly install the leg stretching device according to the present invention in a desired place to use the leg stretching device.

Although it is illustrated and described that the fixed housing 100 according to another embodiment of the present invention is configured to be in the long type bar shape, the present invention is not limited thereto. The shapes or configurations of the fixed housing 100, the movable housing 200, and the auxiliary housings 300 may be variously changed so far as they can firmly maintain the coupling state after they are movably coupled to each other.

Further, in the case where the coupling is performed through the connection portion 400, the fixed housing 100 may be configured so that the configuration of the first insertion holes 130 formed on the upper side of the fixed housing 100 and the connection holes 210 formed on the movable housing 200 is not applied in accordance with the user's selection. As illustrated in FIGS. 3 to 6, second insertion holes 140 are formed on an upper side of the coupling groove 120 to which the auxiliary housings 300 are coupled so that the auxiliary housings 300 are smoothly coupled to both sides of the fixed housing 300.

In the case where the auxiliary housings 300 are coupled to the fixed housing 100, the second insertion holes 140 firmly maintain the coupling of the auxiliary housings 300 to one side of the movable housing 200.

In this case, according to another embodiment of the present invention as described above with reference to FIG. 4, it is described that the configuration of the first insertion holes 130 of the fixed housing 100 and the connection holes 210 of the movable housing 200 is deleted. However, the configuration may also be applied in accordance with the user's selection to firmly achieve the coupling of the fixed housing 100 and the movable housing 200.

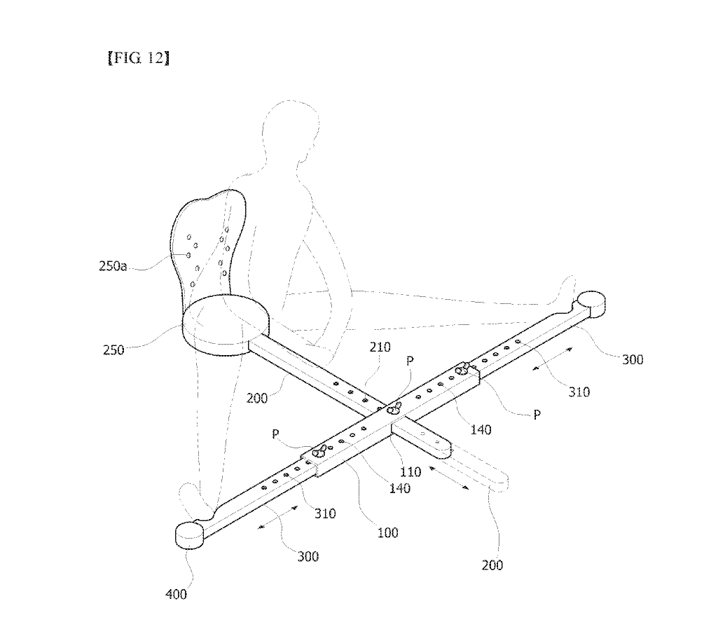

Further, it is preferable that the movable housing 200 and the auxiliary housings 300 are formed of a metal material or a plastic material that has high strength and light weight so as to prevent them from being bent or damaged even in the case where the user uses them to perform the leg stretching as illustrated in FIG. 12.

Hereinafter, the connection portion 400 of the leg stretching device according to another embodiment of the present invention will be described in detail.

The connection portion 400 includes a tension wire 410 penetrating the fixed housing 100 and having one side connected to the movable housing 200 and a connection body 420 detachably coupled to one side of the fixed housing 100 through a fastening bolt P so that the length of the tension wire 410 can be adjusted, and the connection body 420 includes a body portion 421 detachably coupled to one side of the fixed housing 100 through the fastening bolt P and an adjustment handle 422 connected to one side of the tension wire 410 and rotatably coupled to an upper side of the body portion 421.

In this case, the body portion 421 includes a plurality of through-holes 421a to which the fastening bolt P is coupled and a connection hole 421b to which the adjustment handle 422 is rotatably fastened, and the adjustment handle 422 includes a handle body 422a having a movable hole 422a-1 provided on one side thereof and rotatably coupled to the connection hole 421b and a fixed bar 422b connected to the movable hole 422a-1 to be movable upward and downward.

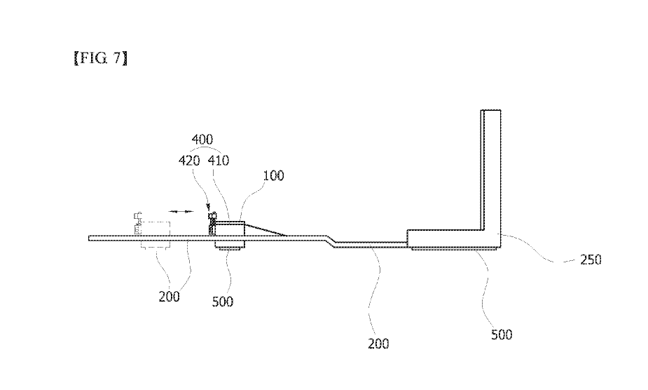

As illustrated in FIGS. 7 to 10, the connection portion 400 is configured to achieve smooth stretching through user's adjustment of the coupling state of the fixed housing 100 and the movable housing 200 in a state where the user who intends to perform the leg stretching is seated on the support means 150 of the fixed housing 100 as well as firmly maintaining the coupling of the fixed housing 100 and the movable housing 200.

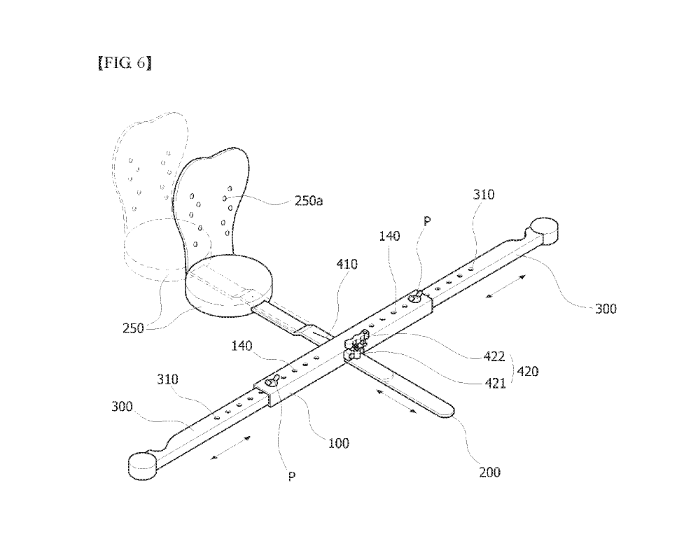

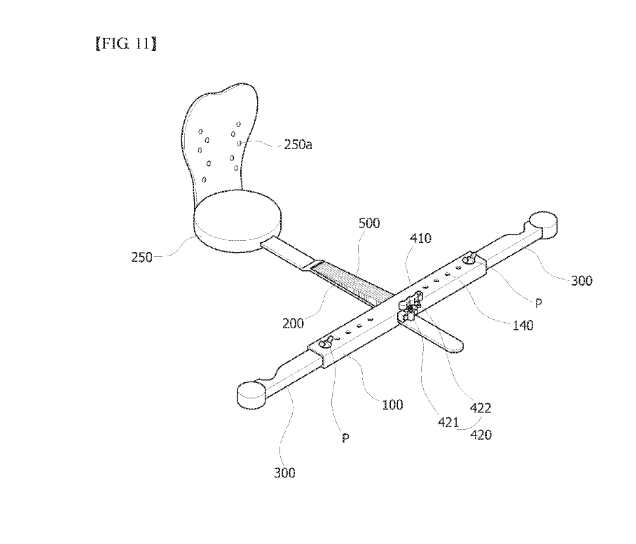

That is, as illustrated in FIG. 6, the user can adjust the coupling of the fixed housing 100 and the movable housing 200 through adjustment of the length of the tension wire 410 that is coupled to the fixed housing 100 and the movable housing 200 in a state where the user grasps the adjustment handle 422 of the connection body 420. After the adjustment of the length of the tension wire 410 through the adjustment handle 422, as illustrated in FIGS. 6 and 11, the fixing bar 422b of the adjustment handle 422 is naturally locked into one side of the movable housing 200 through the configuration of the body portion 421 and the adjustment handle 422 that constitute the connection body 420, and thus the movable housing 200 that is coupled to the fixed housing 100 is prevented from being separated to an outside of the support means 250 that is coupled to the fixed housing 100 to achieve the stable use thereof even after the length of the tension wire 410 is adjusted.

Further, the fixed housing 100 includes a wire connection hole 150 having an inner groove 151 so that the tension wire 410 is penetratingly seated thereon, and a fixing means 160 seated in the groove 151 to fix the moving tension wire 410 is coupled to the wire connection hole 150.

Through the configuration as described above, in the case where the fixed housing 100 and the movable housing 200 are movably coupled to each other through the tension wire 410 of the connection portion 400, the movement of the tension wire 410 is performed inside the wire connection hole 150 especially in a state where the tension wire 410 is seated onto the groove 151 formed inside the wire connection hole 150, and thus the movement of the tension wire 410 through the adjustment handle 420 can be stably performed.

Further, even in the case where the tension wire 410 moves through the configuration of the fixing means 160 to adjust the coupling of the fixed housing 100 and the movable housing 200, the movement of the tension wire 410 that is seated on and coupled to the groove 151 of the wire connection hole 150 can be prevented more smoothly to achieve the stable use thereof.

In addition, the leg stretching device according to the present invention further includes a movement prevention means 500 which is further coupled to lower ends of the movable housing 200 and the auxiliary housings 300 and is formed of any one selected from the group including rubber, synthetic resin, and a metal material to prevent movements of the movable housing 200 and the auxiliary housings 300, and the support means 250 is composed of a chair having a backrest region on which a plurality of pressure projections 250a are arranged.

The configuration of the chair having the movement prevention means 500 and the plurality of pressure projections 250a formed thereon may be variously changed to be applied in the case where the leg stretching device according to an embodiment of the present invention or a leg stretching device according to another embodiment is configured.

Although the present invention has been described with reference to the preferred embodiments in the attached figures, it is noted that equivalents may be employed and substitutions made herein without departing from the scope of the invention as recited in the claims.

1. A leg stretching device comprising:
a fixed housing being in the form of a long type bar and having a fastening hole provided in an inner center portion thereof and a coupling groove provided on both side portions thereof;
a movable housing being in the form of a long type bar to be penetratingly coupled to the fastening hole of the fixed housing to be movable and having a support means provided on one side thereof to enable a user seated thereon; and
a pair of auxiliary housings detachably coupled to the coupling groove of the fixed housing in an opposite direction thereto.

2. A leg stretching device comprising:
a fixed housing being in the form of a long type bar and having a fastening hole provided in an inner center portion thereof and a coupling groove provided on both side portions thereof;
a movable housing being in the form of a long type bar to be penetratingly coupled to the fastening hole of the fixed housing to be movable and having a support means provided on one side thereof to enable a user seated thereon;
a pair of auxiliary housings detachably coupled to the coupling groove of the fixed housing in an opposite direction thereto; and
a connection portion having one side connected to the fixed housing and the other side connected to the movable housing to firmly maintain coupling between the fixed housing and the movable housing and to control movement of the movable housing in a length direction thereof.

3. The leg stretching device according to claim 1, wherein the fixed housing has first insertion holes formed on an upper side of the fastening hole to which the movable housing is coupled and second insertion holes formed on an upper side of the coupling groove to which the auxiliary housings are coupled,
the movable housing has a plurality of connection holes provided in a length direction thereof to correspond to the first insertion holes, and
the auxiliary housing has a plurality of fixing holes provided in a length direction thereof to correspond to the second insertion holes.

4. The leg stretching device according to claim 2, wherein the connection portion includes a tension wire penetrating the fixed housing and having one side connected to the movable housing and a connection body detachably coupled to one side of the fixed housing through a fastening bolt so that a length of the tension wire can be adjusted, and
the connection body includes a body portion detachably coupled to one side of the fixed housing through the fastening bolt and an adjustment handle connected to one side of the tension wire and rotatably coupled to an upper side of the body portion.

5. The leg stretching device according to claim 4, wherein the body portion has a plurality of through-holes to which the fastening bolt is coupled and a connection hole to which the adjustment handle is rotatably fastened, and
the adjustment handle includes a handle body having a movable hole provided on one side thereof and rotatably coupled to the connection hole and a fixed bar connected to the movable hole to be movable upward and downward.

6. The leg stretching device according to claim 4, wherein the fixed housing has a wire connection hole having an inner groove so that the tension wire is penetratingly seated thereon, and
a fixing means seated in the groove to fix the moving tension wire is coupled to the wire connection hole.

7. The leg stretching device according to claim 4, wherein a connection ring to which the tension wire is coupled is further provided on one side of the handle body, and
a cover that is formed to be contractible to prevent the tension wire from being exposed to an outside is further provided on a connection region between the fixed housing and the movable housing to which the tension wire is connected.

8. The leg stretching device according to claim 1, wherein a movement prevention means is further coupled to lower ends of the movable housing and the auxiliary housings, which is formed of any one selected from the group including rubber, synthetic resin, and a metal material to prevent movements of the movable housing and the auxiliary housings.

9. The leg stretching device according to claim 1, wherein the support means is composed of a chair having a backrest region on which a plurality of pressure projections are arranged.

10. The leg stretching device according to claim 2, wherein the fixed housing has first insertion holes formed on an upper side of the fastening hole to which the movable housing is coupled and second insertion holes formed on an upper side of the coupling groove to which the auxiliary housings are coupled,
the movable housing has a plurality of connection holes provided in a length direction thereof to correspond to the first insertion holes, and
the auxiliary housing has a plurality of fixing holes provided in a length direction thereof to correspond to the second insertion holes.

11. The leg stretching device according to claim 2, wherein a movement prevention means is further coupled to lower ends of the movable housing and the auxiliary housings, which is formed of any one selected from the group including rubber, synthetic resin, and a metal material to prevent movements of the movable housing and the auxiliary housings.

12. The leg stretching device according to claim 2, wherein the support means is composed of a chair having a backrest region on which a plurality of pressure projections are arranged.
